(19) United States
(12) Patent Application Publication
(10) Pub. No.: US 2013/0238277 A1
(43) Pub. Date: Sep. 12, 2013

(54) ANGULAR VELOCITY DETECTING DEVICE, ANGULAR VELOCITY DETECTING METHOD, MOVEMENT STATE DETECTING DEVICE AND NAVIGATION DEVICE

(71) Applicants: Hiroshi Sasakura, Nishinomiya-City (JP); Hiroyuki Toda, Nishinomiya-City (JP)

(72) Inventors: Hiroshi Sasakura, Nishinomiya-City (JP); Hiroyuki Toda, Nishinomiya-City (JP)

(73) Assignee: FURUNO ELECTRIC CO., LTD., Nishinomiya-City, Hyogo (JP)

(21) Appl. No.: 13/988,202

(22) PCT Filed: Jul. 15, 2011
(86) PCT No.: PCT/JP2011/066179

§ 371 Date: May 17, 2013

(30) Foreign Application Priority Data
Nov. 18, 2010 (JP) 2010-257377

(51) Int. Cl. G01C 19/5776

(52) U.S. Cl. CPC G01C 19/5776
USPC 702/141; 702/145

(57) ABSTRACT

An angular velocity detecting device which can estimate and detect correct mounting angles of a gyro sensor is achieved using outputs from the gyro sensor. The gyro sensor measures angular velocities in a sensor coordinate system and outputs them to an angular velocity calculating unit. A bias component removing unit of the angular velocity calculating unit carries out time average processing of the sensor coordinate system angular velocities, divides the sensor coordinate system angular velocities by time average values, and outputs them to a misalignment angle estimating unit. The misalignment angle estimating unit calculates, during a period in which a movable body is turning, a roll direction misalignment angle αφ using an angular velocity ω_{y}^{se} in a pitch angle θ direction and an angular velocity ω_{z}^{se} in a heading ψ direction in the sensor coordinate system. The misalignment angle estimating unit calculates a pitch direction misalignment angle Δθ using an angular velocity ωₓ^{se} in a roll angle φ direction and an angular velocity ω_{z}^{se} in the heading ψ direction.

### TECHNICAL FIELD

The present invention relates to an angular velocity detecting device which is installed in a movable body and detects angular velocities of the movable body, and the invention also relates to a movement state detecting device for detecting a movement state of the movable body.

### BACKGROUND ART

Presently, various navigation devices which are mounted to a movable body such as an automobile, and detect a position, a traveling speed, and a heading of the movable body to display information for aiding the travel to a destination have been devised. Such a navigation device detects a self location of the device based on positioning signals from positioning satellites such as GPS satellites, and detects a movement state of the movable body using angular velocities from a gyro sensor, acceleration from an acceleration sensor, etc.

Meanwhile, recently, many personal navigation devices which are not installed in the movable body beforehand but detachable from the movable body are also used.

When using such a personal navigation device, mounting angles to the movable body may become a subject. For example, correct attitude angles may not be detectable because differences are generated between angular velocity detection axes of the gyro sensor and axes based on an absolute azimuth for calculating the attitude in accordance with the mounting angles of the gyro sensor.

For this reason, a vehicle-mounted angular velocity detecting device disclosed in Patent Document 1 detects the mounting angles based on detection results of an acceleration sensor. The vehicle-mounted angular velocity detecting device disclosed in Patent Document 1 corrects the angular velocities, which are outputted from the gyro sensor, based on the detected mounting angles.

### REFERENCE DOCUMENTS OF CONVENTIONAL ART

Patent Document 1: JP2002-243494A

### DISCLOSURE OF THE INVENTION

### Problems to be Solved by the Invention

However, the vehicle-mounted angular velocity detecting device disclosed in Patent Document 1 described above cannot detect the correct mounting angles of the gyro sensor if the mounting angles of the acceleration sensor and the gyro sensor are not identical. In addition, the mounting angles cannot be detected without the correct acceleration detected by the acceleration sensor.

The purpose of the present invention is to achieve an angular velocity detecting device which can estimate and detect correct mounting angles of a gyro sensor using outputs from a gyro sensor.

### SUMMARY OF THE INVENTION

The present invention is directed to an angular velocity detecting device which is mounted to a movable body and detects angular velocities of the movable body. The angular velocity detecting device includes a gyro sensor, a misalignment angle estimating unit, and a coordinates converting unit. The gyro sensor is mounted to the movable body and measures angular velocities in three axes perpendicular to each other in a sensor coordinate system according to mounting angles. The misalignment angle estimating unit estimates angular differences (misalignment angles) in three axes of the gyro sensor perpendicular to each other and three axes of the movable body perpendicular to each other based on the angular velocities in the sensor coordinate system. The coordinates converting unit executes a coordinate conversion calculation from the angular velocities in the sensor coordinate system into angular velocities in a movable body coordinate system based on the angular differences.

With this configuration, the misalignment angles can be estimated only based on the angular velocities measured by the gyro sensor.

The angular velocity detecting device of the present invention may also be provided with a bias component removing unit for removing bias components of the angular velocities. The misalignment angle estimating unit and the coordinates converting unit performs the calculations using the angular velocities after the bias components are removed.

With this configuration, since the bias components contained in the angular velocities measured by the gyro sensor are removed, the misalignment angles can be estimated more accurately.

The bias component removing unit of the angular velocity detecting device of the present invention may remove the bias components by correcting the angular velocities using time average values of the angular velocities outputted from the gyro sensor.

This configuration shows particular processing of the bias component removing unit, and shows one example using the time average values.

The angular velocity detecting device of the present invention may be provided with a frequency analyzing unit for conducting a frequency analysis of the angular velocity and calculating angular velocities which are comprised of frequency components obtained from removing the bias components and frequency components of noise components. The misalignment angle estimating unit and the coordinates converting unit may perform the calculations using the angular velocities outputted from the frequency analyzing unit.

This configuration shows particular processing for removing the bias components and the noise components, and shows one example using the frequency analysis.

The frequency analyzing unit of the angular velocity detecting device of the present invention may conduct the frequency analysis using a wavelet conversion.

This configuration shows more particular processing of the frequency analyzing unit, and shows one example using the wavelet conversion.

The angular velocity detecting device of the present invention may be provided with a turning detection unit for detecting that the movable body is turning based on acceleration of the movable body and the angular velocities detected in the past.

This configuration shows a particular configuration for detecting the turning of the movable body.

The present invention is also directed to a movement state detecting device. The movement state detecting device includes the angular velocity detecting device described above, an attitude angle detecting unit, an acceleration sensor, a positioning unit, and a movement state calculating unit. The attitude angle detecting unit detects attitude angles of the movable body using the angular velocities detected by the angular velocity detecting device. The acceleration sensor detects acceleration of the movable body. The positioning unit receives positioning signals and measures a position, a speed, and a heading of the movable body. The movement state calculating unit calculates a movement state including the position, the speed, and the attitude angle of the movable body using the attitude angles obtained from the attitude angle detecting unit, the acceleration obtained from the acceleration sensor, and the position, the speed, and the heading obtained from the positioning unit.

This configuration shows a configuration of the movement state detecting device including the angular velocity detecting device described above. By providing the angular velocity detecting device described above, since highly-accurate angular velocities are obtained, highly-accurate attitude angles can be detected. Thus, the movement state of the movable body can be detected with high precision.

The present invention is also directed to a navigation device. This navigation device may be provided with the movement state detecting device described above and a user informing unit for informing navigational information containing the movement state.

With this configuration, since the movement state of the movable body can be detected with high precision by providing the movement state detecting device described above, accurate navigation becomes possible.

### Effect of the Invention

According to the present invention, errors of the mounting angles of the gyro sensor can accurately be detected only using the outputs from the gyro sensor. Thus, the attitude angles of the movable body can be accurately detected without being influenced by the angular differences between the axes for detecting the attitude of the movable body and the axes of the measurement of the angular velocities by the gyro sensor.

### BRIEF DESCRIPTION OF THE DRAWINGS

FIG. 1 is a block diagram showing a configuration of an angular velocity detecting device 1 according to a first embodiment.

FIG. 2 is a view illustrating mounting angles of a gyro sensor 20 to a movable body.

FIG. 3 is a block diagram showing a configuration of a movement state detecting device 100 including the angular velocity detecting device 1 according to the first embodiment.

FIG. 4 is a block diagram showing a configuration of an angular velocity detecting device 1A according to a second embodiment.

### MODE OF CARRYING OUT THE INVENTION

An angular velocity detecting device according to a first embodiment of the present invention and a movement state detecting device including the angular velocity detecting device are described with reference to the drawings. The movement state detecting device according to this embodiment is used for various navigation devices, such as vehicle-mounted navigation devices and PNDs (Personal Navigation Devices).

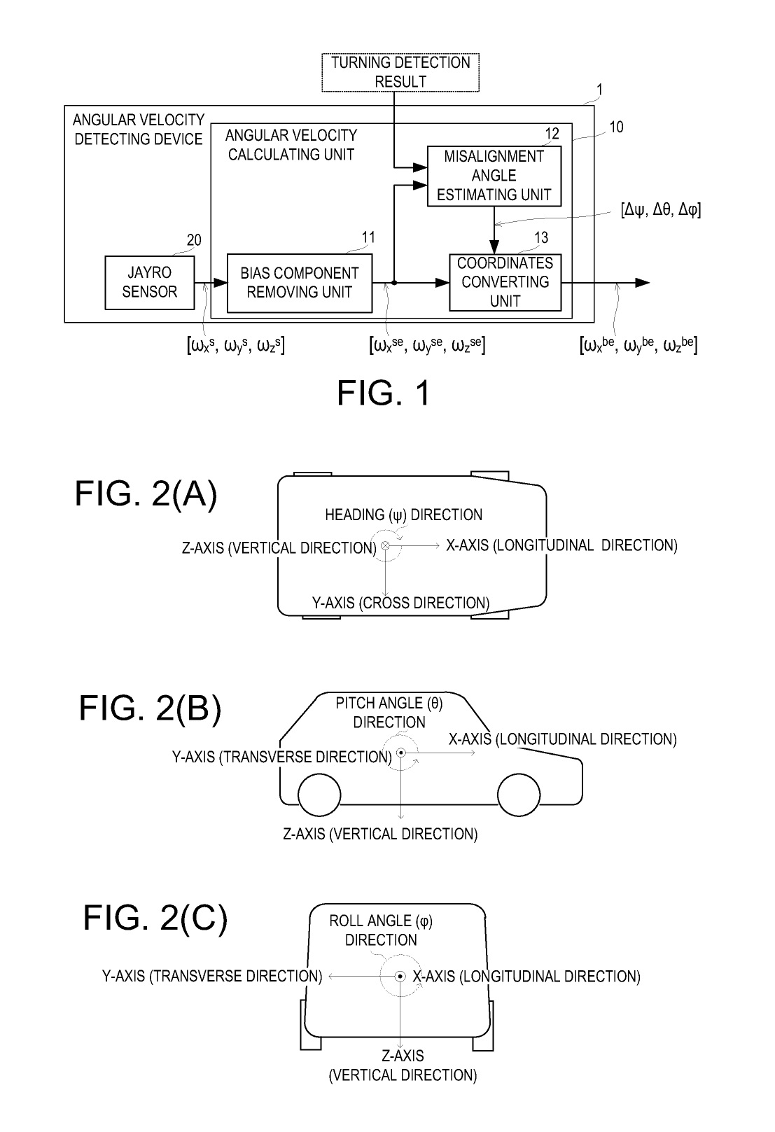

FIG. 1 is a block diagram showing a primary configuration of an angular velocity detecting device 1 of this embodiment. FIG. 2 is a view illustrating detection axes of a gyro sensor 20 in a mounted state to a movable body.

The angular velocity detecting device 1 is provided with an angular velocity calculating unit 10 and the gyro sensor 20.

The gyro sensor 20 measures sensor coordinate system angular velocities [ωₓ^{s}, ω_{y}^{s}, ω_{z}^{s}] in its own coordinate system (sensor coordinate system), as shown in FIG. 2.

The angular velocity ωₓ^{s} is an angular velocity in a direction of roll angle (φ) having x-axis which is in a longitudinal direction of the movable body as its axis of rotation. Here, the angular velocity ωₓ^{s} is detected in a positive direction which is the clockwise direction in a frontal view of the movable body.

The angular velocity ω_{y}^{s} is an angular velocity in a direction of pitch angle (θ) having y-axis which is in a transverse direction of the movable body as its axis of rotation. Here, the angular velocity ω_{y}^{s} is detected in a positive direction which is the clockwise direction in a starboard view of the movable body.

The angular velocity ω_{z}^{s} is an angular velocity in a direction of heading (ψ) having z-axis which is in a vertical direction of the movable body as its axis of rotation. Here, the angular velocity ω_{z}^{s} is detected in a positive direction which is the counterclockwise direction in a plan view of the movable body.

Here, the gyro sensor 20 is assumed to be mounted to the movable body with misalignment angles [Δψ, Δθ, Δφ] which are comprised of an error of mounting angle Δφ in the roll direction, an error of mounting angle Δθ in the pitch direction, and an error of mounting angle Δψ in the heading.

Thus, since the gyro sensor 20 is mounted to the movable body with the misalignment angles [Δψ, Δθ, Δφ], differences may be caused according to solid angles based on the misalignment angles [Δψ, Δθ, Δφ] between respective components of the sensor coordinate system angular velocities [ωₓ^{s}, ω_{y}^{s}, ω_{z}^{s}] and respective components of the movable body coordinate system accelerations which are outputted from the gyro sensor 20. In addition, the gyro sensor 20 regularly contains bias components in the angular velocities outputted, and they cause errors in the outputted angular velocities. Therefore, the angular velocity calculating unit 10 shown below removes these error factors.

The angular velocity calculating unit 10 is provided with a bias component removing unit 11, a misalignment angle estimating unit 12, and a coordinates converting unit 13.

The bias component removing unit 11 carries out time average processing of the angular velocities [ωₓ^{s}, ω_{y}^{s}, ω_{z}^{s}] in the sensor coordinate system, respectively, and calculates average values [Eₐᵥ(ωₓ^{s}), Eₐᵥ(ω_{y}^{s}), Eₐᵥ(ω_{z}^{s})]. The bias component removing unit 11 subtracts the average values [Eₐᵥ(ωₓ^{s}), Eₐᵥ(ω_{y}^{s}), Eₐᵥ(ω_{z}^{s})] from the angular velocities [ωₓ^{s}, ω_{y}^{s}, ω_{z}^{s}] in the sensor coordinate system.

That is, when the angular velocities after the bias components removal processing is assumed to be [ωₓ^{se}, ω_{y}^{se}, ω_{z}^{se}], the following calculation is performed.

[ωₓ^{se},ω_{y}^{se},ω_{z}^{se}]=[ωₓ^{s}−Eₐᵥ(ωₓ^{s}),ω_{y}^{s}−Eₐᵥ(ω_{y}^{s}),ω_{y}^{s}−Eₐᵥ(ω_{z}^{s})]

Processing similar to the time averages may also be used as the bias components removal processing.

Accordingly, the bias components contained in the angular velocities [ωₓ^{s}, ω_{y}^{s}, ω_{z}^{s}] can be removed. The angular velocities after the bias components removal [ωₓ^{se}, ω_{y}^{se}, ω_{z}^{se}] are outputted to the misalignment angle estimating unit 12 and the coordinates converting unit 13.

The turning detection results are also inputted into the misalignment angle estimating unit 12 along with the angular velocities after the bias components removal [ωₓ^{se}, ω_{y}^{se}, ω_{z}^{se}] The turning detection result is information indicative of the identified result whether the movable body is turning. For example, the turning detection result may be set based on the acceleration measured by the acceleration sensor and previously detected angular velocities as will be described later, or, if the movable body is an automobile, it may be set by detecting a rotation of a steering wheel.

The misalignment angle estimating unit 12 estimates the misalignment angles [Δψ, Δθ, Δφ] using the angular velocities [ωₓ^{se}, ω_{y}^{se}, ω_{z}^{se}] after the bias components removal which are acquired during a period of the turning being detected, based on the turning detection result. This estimation of misalignment angles may be, if during the period of turning being detected, carried out every second according to the acquisition timing of the angular velocities in the sensor coordinate system described above, or carried out at every suitably-set timing while buffering the angular velocities in the sensor coordinate system.

Here, the estimated calculation principle of the misalignment angles [Δψ, Δθ, Δφ] is described. The following equation can be established when the angular velocities in the sensor coordinate system after the bias components removal are [ωₓ^{se}, ω_{y}^{se}, ω_{z}^{se}], the angular velocities in the movable body coordinate system are [ωₓ^{be}, ω_{y}^{be}, ω_{z}^{be}] and the misalignment angles are [Δψ, Δθ, Δφ], respectively.

$$[ \begin{matrix}{ω}_{x}^{se} \\ {ω}_{y}^{se} \\ {ω}_{z}^{se}\end{matrix} ] = {C}_{b}^{s} [ \begin{matrix}{ω}_{x}^{be} \\ {ω}_{y}^{be} \\ {ω}_{z}^{be}\end{matrix} ] \qquad ( 1 )$$

C_{b}^{s} is a rotating matrix for converting the movable body coordinate system into the angular velocity sensor coordinate system, and it can be expressed by the following equation using the misalignment angles [Δψ, Δθ, Δφ].

$$\begin{matrix}{C}_{b}^{s} = ( \begin{matrix}1 & 0 & 0 \\ 0 & cos ( Δ φ ) & sin ( Δ φ ) \\ 0 & - sin ( Δ φ ) & cos ( Δ φ )\end{matrix} ) ( \begin{matrix}cos ( Δ θ ) & 0 & - sin ( Δ θ ) \\ 0 & 1 & 0 \\ sin ( Δ θ ) & 0 & cos ( Δ θ )\end{matrix} ) \\ ( \begin{matrix}cos ( Δ ψ ) & sin ( Δ ψ ) & 0 \\ - sin ( Δ ψ ) & cos ( Δ ψ ) & 0 \\ 0 & 0 & 1\end{matrix} ) \\ = ( \begin{matrix}cos ( Δ ψ ) cos ( Δ θ ) & sin ( Δ ψ ) cos ( Δ θ ) & - sin ( Δ θ ) \\ \begin{matrix}- sin ( Δ ψ ) cos ( Δ φ ) + \\ cos ( Δ ψ ) sin ( Δ θ ) sin ( Δ φ )\end{matrix} & \begin{matrix}cos ( Δ ψ ) cos ( Δ φ ) + \\ sin ( Δ ψ ) sin ( Δ θ ) sin ( Δ φ )\end{matrix} & cos ( Δ θ ) cos ( Δ φ ) \\ \begin{matrix}sin ( Δ ψ ) sin ( Δ φ ) + \\ cos ( Δ ψ ) sin ( Δ θ ) cos ( Δ φ )\end{matrix} & \begin{matrix}- cos ( Δ ψ ) cos ( Δ φ ) + \\ sin ( Δ ψ ) sin ( Δ θ ) cos ( Δ φ )\end{matrix} & cos ( Δ θ ) cos ( Δ φ )\end{matrix} )\end{matrix} \qquad ( 2 )$$

Here, when each of the misalignment angles [Δψ, Δθ, Δφ] is Δψ<<1 [rad], Δθ<<1 [rad], and Δφ<<1 [rad], respectively, the rotating matrix C_{b}^{s} can be approximated as the following equation.

$${C}_{b}^{s} = [ \begin{matrix}1 & Δ ψ & - Δ θ \\ - Δ ψ & 1 & Δ φ \\ Δ θ & - Δ φ & 1\end{matrix} ] \qquad ( 3 )$$

Therefore, Equation (1) can also be expressed by the following equation.

$$[ \begin{matrix}{ω}_{x}^{se} \\ {ω}_{y}^{se} \\ {ω}_{z}^{se}\end{matrix} ] = [ \begin{matrix}1 & Δ ψ & - Δ θ \\ - Δ ψ & 1 & Δ φ \\ Δ θ & - Δ θ & 1\end{matrix} ] [ \begin{matrix}{ω}_{x}^{be} \\ {ω}_{y}^{be} \\ {ω}_{z}^{be}\end{matrix} ] \qquad ( 4 )$$

Meanwhile, when the movable body is turning in flatland, it can be considered that the roll angle γ direction component ωₓ^{be} of the angular velocities [ωₓ^{be}, ω_{y}^{be}, ω_{z}^{be}] and the pitch angle θ direction component ω_{y}^{be} in the movable body coordinate system are “0,” respectively. That is, ωₓ^{be}=0 and ω_{y}^{be}=0.

Therefore, Equation (4) can also be expressed as the following equation.

$$[ \begin{matrix}{ω}_{x}^{se} \\ {ω}_{y}^{se} \\ {ω}_{z}^{se}\end{matrix} ] = [ \begin{matrix}1 & Δ ψ & - Δ θ \\ - Δ ψ & 1 & Δ φ \\ Δ θ & - Δ φ & 1\end{matrix} ] [ \begin{matrix}0 \\ 0 \\ {ω}_{z}^{be}\end{matrix} ] = [ \begin{matrix}- Δ θ \cdot {ω}_{z}^{be} \\ Δ φ \cdot {ω}_{z}^{be} \\ {ω}_{z}^{be}\end{matrix} ] \qquad ( 5 )$$

Thus, when the angular velocity ω_{z}^{be} in the sensor coordinate system in the heading ψ direction is not “0,” the roll direction misalignment angle Δφ and the pitch direction misalignment angle Δθ are calculated from the following equation.

$$\begin{matrix}Δ φ = \frac{{ω}_{y}^{se}}{{ω}_{z}^{se}} & ( 6 A ) \\ Δ θ = - \frac{{ω}_{x}^{se}}{{ω}_{z}^{se}} & ( 6 B )\end{matrix}$$

As described above, the roll direction misalignment angle Δφ and the pitch direction misalignment angle Δθ can be estimated and calculated only from the angular velocities [ωₓ^{se}, ω_{y}^{se}, ωₛ^{se}] measured by the gyro sensor.

Here, it may be better to perform time average processing to the roll direction misalignment angle Δφ and the pitch direction misalignment angle Δθ to be calculated. The time average processing herein refers to common time average processing where the sum total of instantaneous values of the misalignment angles is calculated based on the angular velocities at respective sampling timings and the sum total is divided by the number of samplings. Specifically, if the sign of time average value processing is set to E[ ], the following equations may be calculated.

$$\begin{matrix}Δ φ = {E}_{Δ φ} [ \frac{{ω}_{y}^{se}}{{ω}_{z}^{se}} ] & ( 7 A ) \\ Δ θ = {E}_{Δ θ} [ - \frac{{ω}_{x}^{se}}{{ω}_{z}^{se}} ] & ( 7 B )\end{matrix}$$

However, this time average processing is also performed only during the period of turning.

Note that, although, in the above, one example where errors included in the roll direction misalignment angle Δφ and the pitch direction misalignment angle Δθ are removed using the simple time average processing is shown, processing equivalent to the time average processing may also be performed using a primary low-pass filter as shown below.

Here, although the case where the primary low-pass filter (LPF) processing is performed to the roll direction misalignment angle Δφ is shown as one example, the primary low-pass filter processing may similarly be performed for other pitch direction misalignment angles Δθ.

Assuming that the roll direction misalignment angle Δφ at a certain sampling timing t is Δφ[t] and the roll direction misalignment angle Δφ at the next sampling timing is Δφ[t+1], the following equation can be set.

$$Δ φ [ t + 1 ] = Δ φ [ t ] + α \cdot ( \frac{{ω}_{y}^{se}}{{ω}_{z}^{se}} - Δ φ [ t ] ) \qquad ( 8 )$$

Here, when ω_{z}^{se}=0 or the movable body is traveling straight, it is considered to be Δφ[t+1]=Δφ[t].

In addition, α is the weight of LPF and the value will be changed according to the following conditions.

(i) A case where ω_{z}^{se}≠0, the movable body is turning on a flat road, and the value of (ω_{y}^{se}/ω_{z}^{se}−Δφ[t]) is below a threshold β. In this case, the misalignment angle Δφ is smaller and it is considered to be α=α₁.

(ii) A case where ω_{z}^{se}≠0, the movable body is turning on a flat road, and the value of (ω_{y}^{se}/ω_{z}^{se}−Δφ[t]) is not below the threshold β. In this case, the misalignment angle Δφ is larger and it is considered to be α=α₂.

Here, the weights α₁ and α₂ are set as 0<α1<α2<1. The threshold β is a value set according to experiments.

When filtering which varies such weights is used, for example, when a user changes the orientation of the device (i.e., when the misalignment angle is larger), a heavier weight is added to the presently-calculated misalignment angle. On the other hand, when the misalignment angle is smaller, a heavier weight is added to the previously-calculated misalignment angles. Therefore, when the misalignment angle changes greatly with the change of the device's orientation, the misalignment angle can quickly be converged into the misalignment angle after the change, and in a situation where the misalignment angle hardly changes such as when the orientation of the device is not changed, the effects by the calculation errors of the angular velocities can be suppressed.

Note that Kalman filter processing may be used instead of such low-pass filter processing or the time average processing described above.

The misalignment angle calculated in this way is outputted to the coordinates converting unit 13. Here, if the movable body is a land vehicle, the roll angle φ and the pitch angle θ have a less variation with respect to the heading ψ and, thus, the roll angle φ and the pitch angle θ hardly effect on the heading ψ. Therefore, the heading direction misalignment angle Δψ can be approximated to “0.”

The coordinates converting unit 13 calculates, based on the misalignment angles [Δψ, Δθ, Δφ] which were estimated and calculated by the misalignment angle estimating unit 12, the angular velocities [ω_{w}^{be}, ω_{y}^{be}, ω_{z}^{be}] in the movable body coordinate system by converting coordinates of the angular velocities [ωₓ^{se}, ω_{y}^{se}, ω_{z}^{se}] in the sensor coordinate system outputted from the bias component removing unit 11.

Specifically, this correction is based on the following principle. When angular velocities in the sensor coordinate system are assumed to be [ωₓ^{se}, ω_{y}^{se}, ω_{z}^{se}] and angular velocities in the movable body coordinate system are assumed to be [ωₓ^{be}, ω_{y}^{be}, ω_{z}^{be}], respectively, the following equation can be established as described above.

$$[ \begin{matrix}{ω}_{x}^{be} \\ {ω}_{y}^{be} \\ {ω}_{z}^{be}\end{matrix} ] = {C}_{s}^{b} [ \begin{matrix}{ω}_{x}^{se} \\ {ω}_{y}^{se} \\ {ω}_{z}^{se}\end{matrix} ] \qquad ( 9 )$$

Cₛ^{b} is a rotating matrix for converting the movable body coordinate system into the angular velocity sensor coordinate system, and it can be expressed by the following equation using the misalignment angles [Δψ, Δθ, Δφ] which are calculated by the estimation.

$$\begin{matrix}{C}_{s}^{b} = ( \begin{matrix}cos ( Δ ψ ) & - sin ( Δ ψ ) & 0 \\ sin ( Δ ψ ) & cos ( Δ ψ ) & 0 \\ 0 & 0 & 1\end{matrix} ) ( \begin{matrix}cos ( Δ θ ) & 0 & sin ( Δ θ ) \\ 0 & 1 & 0 \\ - sin ( Δ θ ) & 0 & cos ( Δ θ )\end{matrix} ) \\ ( \begin{matrix}1 & 0 & 0 \\ 0 & cos ( Δ φ ) & - sin ( Δ φ ) \\ 0 & sin ( Δ φ ) & cos ( Δ φ )\end{matrix} ) \\ = ( \begin{matrix}cos ( Δ ψ ) cos ( Δ θ ) & \begin{matrix}- sin ( Δψ ) cos ( Δ φ ) + \\ cos ( Δ ψ ) sin ( Δ θ ) sin ( Δ φ )\end{matrix} & \begin{matrix}sin ( Δ ψ ) sin ( Δ φ ) + \\ cos ( Δ ψ ) sin ( Δ θ ) cos ( Δ φ )\end{matrix} \\ sin ( Δ ψ ) cos ( Δ θ ) & \begin{matrix}cos ( Δ ψ ) cos ( Δ φ ) + \\ sin ( Δ ψ ) sin ( Δ θ ) sin ( Δ φ )\end{matrix} & \begin{matrix}- cos ( Δ ψ ) sin ( Δ φ ) + \\ sin ( Δ ψ ) sin ( Δ θ ) cos ( Δ φ )\end{matrix} \\ - sin ( Δ θ ) & cos ( Δ θ ) sin ( Δ φ ) & cos ( Δ θ ) cos ( Δ φ )\end{matrix} )\end{matrix} \qquad ( 10 )$$

Note that, when the misalignment angles [Δψ, Δθ, Δφ] are Δφ<<1 [rad], Δθ<<1 [rad], and Δφ<<1 [rad], respectively, the rotating matrix Cₛ^{b} can be approximated as the following equation.

$${C}_{s}^{b} = [ \begin{matrix}1 & - Δ ψ & Δ θ \\ Δ ψ & 1 & - Δ φ \\ - Δ θ & Δ φ & 1\end{matrix} ] \qquad ( 11 )$$

The coordinates converting unit 13 converts the angular velocities [ωₓ^{se}, ω_{y}^{se}, ω_{z}^{se}] in the sensor coordinate system after the bias components removal into the angular velocities [ωₓ^{be}, ω_{y}^{be}, ω_{z}^{be}] in the movable body coordinate system using such a rotating matrix Cₛ^{b}.

Thus, since the corrections by the misalignment angles are performed, the angular velocities [ωₓ^{be}, ω_{y}^{be}, ω_{z}^{be}] in the movable body coordinate system to be calculated will be highly-accurate values. Further, since the bias components are removed as described above, the angular velocities [ωₓ^{be}, ω_{y}^{be}, ω_{z}^{be}] will be even more accurate values.

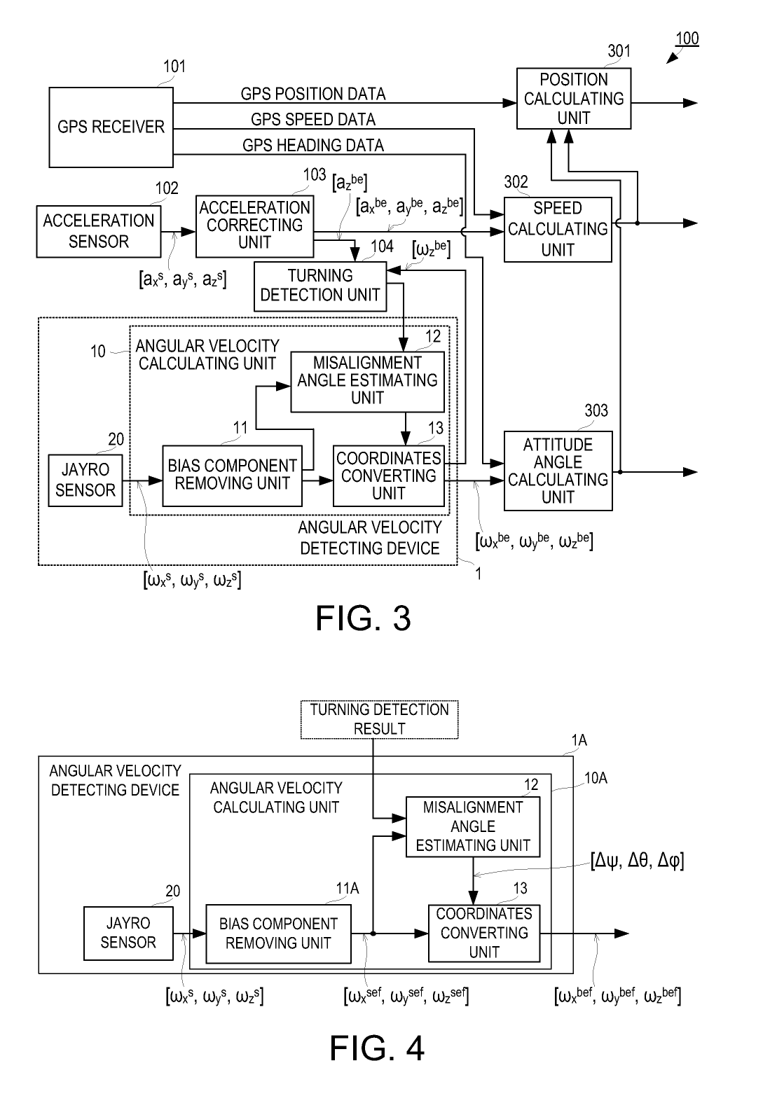

The angular velocity detecting device 1 having such a configuration is mounted on a movement state detecting device 100 as shown in FIG. 3. FIG. 3 is a block diagram showing a configuration of the movement state detecting device 100 including the angular velocity detecting device 1 according to this embodiment.

The movement state detecting device 100 is provided with a GPS receiver 101, an acceleration sensor 102, an acceleration correcting unit 103, a turning detection unit 104, a position calculating unit 301, a speed calculating unit 302, and an attitude angle calculating unit 303, in addition to the angular velocity detecting device 1 described above.

The GPS receiver 101 receives GPS signals from GPS Satellites and performs positioning by a known method based on the received GPS signals to calculate GPS position data, GPS speed data, and GPS heading data. The GPS receiver 101 outputs the GPS position data to the position calculating unit 301, and outputs the GPS speed data to the speed calculating unit 302 and the GPS heading data to the attitude angle calculating unit 303, respectively.

Like the gyro sensor 20, the acceleration sensor 102 is installed to the movable body in a predetermined manner, and measures accelerations [aₓ^{s}, a_{y}^{s}, a_{z}^{s}] in the sensor coordinate system as its own coordinate system (acceleration sensor coordinate system).

The acceleration a: is acceleration in the x-axis which is in a longitudinal direction of the movable body. The acceleration a_{y}^{s} is acceleration in the y-axis which is a transverse direction of the movable body. The acceleration a_{z}^{s} is acceleration in the vertical direction of the movable body.

The acceleration sensor 102 outputs the measured accelerations [aₓ^{s}, a_{y}^{s}, a_{z}^{s}] in the sensor coordinate system to the acceleration correcting unit 103.

The acceleration correcting unit 103 performs, for the accelerations [aₓ^{s}, a_{y}^{s}, a_{z}^{s}] in the sensor coordinate system, the correction of the errors caused by the misalignment angles of the acceleration sensor, and the correction to remove the bias components and the noise components. The acceleration correcting unit 103 converts the corrected accelerations into the coordinate system of the movable body to generate accelerations [aₓ^{be}, a_{y}^{be}, a_{z}^{be] in the movable body coordinate system. The accelerations [a}ₓ^{be}, a_{y}^{be}, a_{z}^{be] in the movable body coordinate system are outputted to the speed calculating unit 302. The acceleration a}_{z}^{be} in the z-axis direction (vertical direction) in the movable body coordinate system is outputted also to the turning detection unit 104.

If the value of acceleration a_{z}^{be} in the z-axis direction (vertical direction) is below a predetermined threshold, the turning detection unit 104 determines that the movable body exists in a flatland. Further, if the value of angular velocity ω_{z}^{be} in the heading ψ direction detected immediately before is above a predetermined threshold, the turning detection unit 104 detects that the movable body is turning. If it determines that such two conditions are satisfied, the turning detection unit 104 outputs the turning detection result indicative of that the movable body is turning to the misalignment angle estimating unit 12 of the angular velocity detecting device 1.

The angular velocity detecting device 1 performs the above-described coordinate conversion of the angular velocities [ωₓ^{s}, ω_{y}^{s}, ω_{z}^{s}] in the sensor coordinate system measured by the gyro sensor 20 to generate the angular velocities [ωₓ^{be}, ω_{y}^{be}, ω_{z}^{be}] in the movable body coordinate system. The angular velocities [ωₓ^{be}, ω_{y}^{be}, ω_{z}^{be}] in the movable body coordinate system are outputted to the attitude angle calculating unit 303.

The speed calculating unit 302 outputs the GPS speed data while the GPS speed data is inputted. If the GPS speed data is not inputted, the speed calculating unit 302 integrates the accelerations [aₓ^{be}, a_{y}^{be}, a_{z}^{be}] using the inputted final GPS speed data as initial values to calculate and output the speed data. Note that, even while the GPS speed data is inputted, speed data can also be generated using the accelerations [aₓ^{be}, a_{y}^{be}, a_{z}^{be}]. In this case, the speed calculating unit 302 simply calculates the present speed data by carrying out a weighting addition of values obtained by integrating the accelerations [aₓ^{be}, a_{y}^{be}, a_{z}^{be}] for the previously-outputted speed data, and values of the present GPS speed data.

The attitude angle calculating unit 303 outputs the GPS heading data while the GPS heading data is inputted. If the GPS heading data is not inputted, the attitude angle calculating unit 303 integrates the angular velocities [ωₓ^{be}, ω_{y}^{be}, ω_{z}^{be}] using the inputted final GPS heading data as initial values to calculate and output heading data. Note that, even while the GPS heading data is inputted, heading data can also be generated using the angular velocities [ωₓ^{be}, ω_{y}^{be}, ω_{z}^{be}]. In this case, the attitude angle calculating unit 303 simply calculates the present heading data by carrying out a weighting addition of values obtained by integrating the angular velocities [ωₓ^{be}, ω_{y}^{be}, ω_{z}^{be}] for the previously-outputted heading data, and values of the present GPS heading data.

The position calculating unit 301 outputs the GPS position data while the GPS position data is inputted. If the GPS position data is not inputted, the position calculating unit 301 integrates speed vectors obtained from the accelerations [aₓ^{be}, a_{y}^{be}, a_{z}^{be}] and the angular velocities [ωₓ^{be}, ω_{y}^{be}, ω_{z}^{be}] using the inputted final GPS position data as initial values to calculate and output position data. Even while the GPS position data is inputted, the position data can also be generated using the accelerations [aₓ^{be}, a_{y}^{be}, a_{z}^{be}] and the angular velocities [ωₓ^{be}, ω_{y}^{be}, ω_{z}^{be}]. In this case, the position calculating unit 301 simply calculates the present position data by carrying out a weighting addition of values obtained by integrating speed vectors obtained from the accelerations [aₓ^{be}, a_{y}^{be}, a_{z}^{be}] and the angular velocities [ωₓ^{be}, ω_{y}^{be}, ω_{z}^{be}] for the previously-outputted position data, and values of the present GPS position data.

As described above, the position, the speed, and the attitude angle (heading) of the movable body can be calculated using the configuration of FIG. 3. In addition, by providing the angular velocity detecting device 1 described above, the attitude angle can be detected with high precision and the speed can also be detected with high precision by the same method. Therefore, even if it becomes in a state where the GPS signals cannot be received, the position, the speed, and the attitude angle (heading) of the movable body can be calculated with high precision.

The various movement information on the movable body which is calculated with high precision are used for navigation processing and the like in the navigation device where the movement state detecting device 1 is implemented. This navigation device at least includes a navigation processing unit for performing route navigation processing, a display unit, and a user interface unit which can also be served by the display unit. For example, the navigation unit calculates, according to an operational input from the user interface unit a current position of the movable body and an optimal route from a target position, and displays the route on the display unit. As described above, since the movement information on the movable body can be obtained with high precision, the navigation device can achieve accurate navigation processing.

Next, an angular velocity detecting device according to a second embodiment is described with reference to the drawings. FIG. 4 is a block diagram showing a configuration of an angular velocity detecting device 1A according to this embodiment. In the angular velocity detecting device 1A of this embodiment, the bias component removing unit 11 is replaced by a frequency analyzing unit 11A, as compared with the angular velocity detecting device 1 shown in the first embodiment and, thus, other configurations are the same. Therefore, only different points will be described in detail.

The frequency analyzing unit 11A converts angular velocities [ωₓ^{be}, ω_{y}^{be}, ω_{z}^{be}] in the sensor coordinate system into a group of angular velocity components on a frequency axis by a wavelet conversion. More specifically, the frequency analyzing unit 11A acquires the angular velocities [ωₓ^{be}, ω_{y}^{be}, ω_{z}^{be}] in the sensor coordinate system, for example; every second, and stores them for 64 seconds. The frequency analyzing unit 11A performs the wavelet conversion based on these data for 64 seconds.

The frequency analyzing unit 11A acquires substantially steady components corresponding to a sampling period of 64 seconds (DC components), varying components corresponding to a sampling period of 32 seconds (AC components), varying components corresponding to a sampling period of 16 seconds (AC components), varying components corresponding to a sampling period of 8 seconds (AC components), varying components corresponding to a sampling period of 4 seconds (AC components), varying components corresponding to a sampling period of 2 seconds (AC components), and varying components corresponding to a sampling period of 1 second (AC components).

The frequency analyzing unit 11A uses the acquired 64-second width DC components of a super-low frequency range as bias frequency components, uses the 8-second width AC components of a middle frequency range, the 4-second width AC components, and the 2-second width AC components as movement angular velocity frequency components, and sets the 1-second width AC components to noise frequency components. These classifications of frequency ranges are set by the principle shown below.

First, it can be considered that the DC components obtained from the 64-second width are outputted substantially steadily from the angular velocity sensor 20 without depending on the movement state of the movable body. Next, it can be considered that the AC components obtained from 8-second width, 4-second width, and 2-second width are greatly influenced by the movement state of the movable body and easy to depend on the movement angular velocity of the movable body. Next, it can be considered that the AC components obtained from 1-second width contains more random natures compared with the movement angular velocity of the movable body.

The frequency analyzing unit 11 outputs the movement angular velocity frequency components obtained from the wavelet conversion as angular velocity after the error factors are removed [ωₓ^{be}, ω_{y}^{be}, ω_{z}^{be}] to the misalignment angle estimating unit 12 and the coordinates converting unit 13.

By using such a configuration, the misalignment angles are estimated and corrected by the angular velocities which are obtained by removing the bias components and the noise components from the angular velocities [ωₓ^{be}, ω_{y}^{be}, ω_{z}^{be}] measured by the gyro sensor 20. Therefore, the highly-accurate angular velocities in the movable body coordinate system can be calculated.

Note that the above description shows the example where the frequency analyzing unit 11A performs the wavelet conversion. Desirably, the wavelet conversion is used; however, other frequency conversion, for example, Fourier transformation or the like may be performed, or resolution may be made into respective frequency components by a plurality of filters having different pass frequency bands.

Further, although the above description shows the example where the angular velocity calculating unit 10 is functionally divided into the bias component removing unit 11 or the frequency analyzing unit 11A, the misalignment angle estimating unit 12, and the coordinates converting unit 13, these components may be achieved by one arithmetic element and executive programs.

Further, although, in the above description, the heading direction misalignment angle Δψ is set to substantially “0” and estimation is not carried out, the estimated calculation can be carried out by a method shown below.

Estimation of the heading direction misalignment angle Δψ is performed for a period in which the movable body travels straight on a sloped road. When the movable body is traveling straight on the sloped road, it can be considered that the roll angle φ direction component ωₓ^{be} and the heading θ direction component ω_{z}^{be} of the angular velocities [ωₓ^{be}, ω_{y}^{be}, ω_{z}^{be}] in the movable body coordinate system are “0.” That is, ωₓ^{be}=0 and ω_{z}^{be}=0.

Therefore, Equation (4) can be expressed as the following equation.

$$[ \begin{matrix}{ω}_{x}^{se} \\ {ω}_{y}^{se} \\ {ω}_{z}^{se}\end{matrix} ] = [ \begin{matrix}1 & Δ ψ & - Δ θ \\ - Δ ψ & 1 & Δ φ \\ Δ θ & - Δ φ & 1\end{matrix} ] [ \begin{matrix}0 \\ {ω}_{y}^{be} \\ 0\end{matrix} ] = [ \begin{matrix}Δ ψ \cdot {ω}_{y}^{be} \\ {ω}_{y}^{be} \\ - Δ φ \cdot {ω}_{y}^{be}\end{matrix} ] \qquad ( 12 )$$

By this equation, when the movable body is traveling on the sloped road (i.e., when the angular velocity ω_{y}^{se} in the sensor coordinate system in the pitch angle ψ direction is not “0”), the heading direction misalignment angle Δψ can be calculated from the following equation.

$$Δ φ = \frac{{ω}_{z}^{se}}{{ω}_{y}^{se}} \qquad ( 13 )$$

Thus, the heading direction misalignment angle Δφ can also be estimated and calculated only from the angular velocities [ωₓ^{se}, ω_{y}^{se}, ω_{z}^{se}] measured by the gyro sensor.

As described above, since the misalignment angles of all directions can be estimated and calculated if the heading direction misalignment angle Δψ can be calculated, the angular velocities [ωₓ^{se}, ω_{y}^{se}, ω_{z}^{se}] detected by the gyro sensor 20 can be corrected with even higher precision.

### DESCRIPTION OF NUMERALS

1 and 1A: Angular Velocity Detecting Device; 10 and 10A: Angular Velocity Calculating Unit; 11: Bias Component Removing Unit; 11A: Frequency Analyzing Unit; 12: Misalignment Angle Estimating Unit; 13: Coordinates Converting Unit; 20: Gyro Sensor; 100: Movement State Detecting Device; 101: GPS Receiver; 102: Acceleration Sensor; 103: Acceleration Correcting Unit; 104: Turning Detection Unit; 301: Position Calculating Unit; 302: Speed Calculating Unit; and 303: Attitude Angle Calculating Unit.

1. An angular velocity detecting device mounted to a movable body and for detecting angular velocities of the movable body, comprising:
a gyro sensor for measuring angular velocities in three axes perpendicular to each other in a sensor coordinate system;
a misalignment angle estimating unit for estimating, based on the angular velocities in the sensor coordinate system, angular differences between the three axes of the gyro sensor perpendicular to each other and three axes of the movable body perpendicular to each other; and
a coordinates converting unit for converting the angular velocities in the sensor coordinate system into angular velocities in a movable body coordinate system based on the angular differences.

2. The angular velocity detecting device of claim 1, comprising a bias component removing unit for removing bias components of the angular velocities, wherein the misalignment angle estimating unit and the coordinates converting unit performs the calculations using the angular velocities after the bias components are removed.

3. The angular velocity detecting device of claim 2, wherein the bias component removing unit removes the bias components by correcting the angular velocities using time average values of the angular velocities outputted from the gyro sensor.

4. The angular velocity detecting device of claim 1, comprising a frequency analyzing unit for performing a frequency analysis of the angular velocities and calculating angular velocities comprised of frequency components obtained by removing the frequency components of the bias components and the noise components, wherein the misalignment angle estimating unit and the coordinates converting unit performs the calculations using the angular velocities outputted from the frequency analyzing unit.

5. The angular velocity detecting device of claim 4, wherein the frequency analyzing unit performs the frequency analysis using a wavelet conversion.

6. The angular velocity detecting device of claim 1, comprising a turning detection unit for detecting that the movable body is turning based on acceleration of the movable body and angular velocities detected in the past.

7. The angular velocity detecting device of claim 1, comprising:
an attitude angle detecting unit for detecting an attitude angle of the movable body using the angular velocities detected by the angular velocity detecting device;
an acceleration sensor for detecting acceleration of the movable body;
a positioning unit for receiving positioning signals and measuring a position, a speed, and a heading of the movable body; and
a movement state calculating unit for calculating a movement state containing a position, a speed, and an attitude angle of the movable body using the attitude angle obtained from the attitude angle detecting unit, the acceleration obtained from the acceleration sensor, and the position, the speed and the heading obtained from the positioning unit.

8. The movement state detecting device of claim 7, comprising a user informing unit for informing navigational information containing the movement state.

9. An angular velocity detecting method for detecting angular velocities of a movable body, comprising the steps of:
measuring angular velocities in three axes perpendicular to each other;
estimating, based on the angular velocities on the three axes perpendicular to each other, angular differences between the three axes of a gyro sensor perpendicular to each other and three axes of the movable body perpendicular to each other,
converting the angular velocities in a sensor coordinate system into angular velocities in a movable body coordinate system based on the angular differences.

10. The angular velocity detecting method of claim 9, comprising removing bias components of the angular velocities, wherein the estimating angular differences and the converting the angular velocities include performing the calculations using the angular velocities after the bias components are removed.

11. The angular velocity detecting method of claim 10, wherein the removing bias components includes removing the bias components by correcting the angular velocities using time average values of the measured angular velocities.

12. The angular velocity detecting method of claim 9, comprising performing a frequency analysis of the angular velocities and calculating angular velocities comprised of frequency components obtained by removing the frequency components of the bias components and the noise components, wherein the estimating angular differences and the converting the angular velocities include performing the calculations using the angular velocities calculated by the performing a frequency analysis.

13. The angular velocity detecting method of claim 12, wherein the performing a frequency analysis includes performing the frequency analysis using a wavelet conversion.

14. The angular velocity detecting method of claim 9, comprising detecting that the movable body is turning based on acceleration of the movable body.
